(19) United States
(12) Patent Application Publication
(10) Pub. No.: US 2025/0092769 A1
(43) Pub. Date: Mar. 20, 2025

(54) DETERMINING ANGULAR POSITION OF A ROTOR IN A DOWNHOLE ELECTRIC SUBMERSIBLE PUMP (ESP) ELECTRIC MOTOR

(71) Applicant: Halliburton Energy Services, Inc., Houston, TX (US)

(72) Inventors: Ketankumar Kantilal Sheth, Tulsa, OK (US); Jeffrey Frey, Tulsa, OK (US); Trevor Alan Kopecky, Tulsa, OK (US); Donn J. Brown, Tulsa, OK (US)

(21) Appl. No.: 18/370,060

(22) Filed: Sep. 19, 2023

(51) Int. Cl. E21B 43/12; F04D 25/06; F04D 29/10; G01B 7/30

(52) U.S. Cl. CPC E21B 43/128; F04D 13/10; F04D 15/0272; F04D 29/106; G01B 7/30

(57) ABSTRACT

An electric submersible pump (ESP) assembly. The ESP assembly comprises having an electric motor a stator, a rotor, and a first drive shaft, wherein the rotor is coupled to the first drive shaft; a seal section having a second drive shaft coupled to the first drive shaft; a pump assembly having a third drive shaft coupled to the second drive shaft; and an angular position instrument that is configured to determine an angular position of the rotor and to transmit an indication of the angular position of the rotor to an electric motor controller.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Electrical submersible pumps (hereafter “ESP” or “ESPs”) may be used to lift well fluid in a wellbore. Specifically, ESPs may be used to pump the well fluid to the surface in wells with low reservoir pressure. ESPs may be of importance in wells having low bottomhole pressure or for use with well fluids having a low gas/oil ratio, a low bubble point, and/or a high water cut. Moreover, ESPs may also be used in any production operation to increase the flow rate of the well fluid to a target flow rate.

Generally, an ESP comprises an electric motor, a seal section, a pump intake, and one or more pumps (e.g., a centrifugal pump). These components may all be connected with a series of shafts. For example, the pump shaft may be coupled to the motor shaft through the intake and seal shafts. An electric power cable provides electric power to the electric motor from the surface. The electric motor supplies mechanical torque to the shafts, which provide mechanical power to the pump. Well fluids may enter the wellbore where they may flow past the outside of the motor to the pump intake. These well fluids may then be produced by being pumped to the surface inside the production tubing via the pump, which discharges the well fluids into the production tubing.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is an illustration of an electric submersible pump (ESP) assembly disposed in a wellbore at a well site according to an embodiment of the disclosure.

FIG. 2 is an illustration of a cross-section of a rotor of a permanent magnet motor of an ESP according to an embodiment of the disclosure.

FIG. 3 is an illustration of a cross-section of an electric motor of an ESP according to an embodiment of the disclosure.

FIG. 4A is an illustration of a first angular position detector of an ESP according to an embodiment of the disclosure.

FIG. 4B and FIG. 4C are illustrations of a second angular position detector of an ESP according to an embodiment of the disclosure.

FIG. 5 is a flowchart of a method according to an embodiment of the disclosure.

FIG. 6 is a flowchart of another method according to an embodiment of the disclosure.

FIG. 7 is an illustration of an electric motor according to an embodiment of the disclosure.

FIG. 8 is an illustration of a horizontal pump system (HPS) according to an embodiment of the disclosure.

FIG. 9 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As used herein, orientation terms “upstream,” “downstream,” “up,” and “down” are defined relative to the direction of flow of well fluid in the well casing. “Upstream” is directed counter to the direction of flow of well fluid, towards the source of well fluid (e.g., towards perforations in well casing through which hydrocarbons flow out of a subterranean formation and into the casing). “Downstream” is directed in the direction of flow of well fluid, away from the source of well fluid. “Down” is directed counter to the direction of flow of well fluid, towards the source of well fluid. “Up” is directed in the direction of flow of well fluid, away from the source of well fluid. As used herein, the term “about” when referring to a measured value or fraction means a range of values+/−5% of the nominal value stated. Thus, “about 1 inch,” in this sense of “about,” means the range 0.95 inches to 1.05 inches, and “about 5000 PSI,” in this sense of “about,” means the range 4750 PSI to 5250 PSI. Thus, the fraction “about 8/10 s” means the range 76/100 s to 84/100 s.

The present disclosure teaches determining an angular position of a rotor of an electric motor in an ESP assembly or in an electric motor located at or above the surface. While in a preferred embodiment, the rotor comprises permanent magnets and is disposed in a permanent magnet motor or a permanent magnet electric submersible motor (PMESM), it will be appreciated that the teachings of the disclosure are applicable and beneficial in other electric motors, for example an AC induction motor, that are not permanent magnet motors. It can be beneficial when starting electric motors-particularly permanent magnet motors (PMMs)—to know what the angular position of the rotor is before attempting to start the electric motor. If the rotor is in an undesirable position for starting, the electric motor can be pulsed briefly with electric power to cause the rotor to move slightly. If the rotor is then in a desirable position for starting, normal start-up of the electric motor can proceed. If the rotor remains in an undesirable position, the electric motor can be pulsed again until the rotor comes to rest in a desirable position for starting.

In an AC induction motor start-up is typically easier than in a PMM, because initially the rotor is de-energized and presents no magnetic pole that may resist turning if the rotor is in an undesirable position for start-up. By contrast, the magnetic poles of the rotor of the PMM remain permanently energized and, if the rotor is in an undesirable position for start-up, these magnetic poles can resist initiation of turning. In some cases, the rotor of a PMM may repeatedly cog back and forth during start-up when the rotor is an undesirable position for start-up, acting in some respects like an impact wrench, delivering hammer-like blows to the ESP assembly and shortening service life of the ESP assembly.

In an embodiment, an angular position instrument is taught that senses or detects spatially distinctive properties of an angular position encoder that is mechanically coupled to a drive shaft of the electric motor. As the drive shaft turns, the angular position encoder turns. The angular position instrument determines, from sensing the spatially distinctive properties of the angular position encoder, an angular position of the encoder and hence of the drive shaft. The angular position instrument is affixed statically at a known angular position relative to a stator of the electric motor, for example affixed to the stator and/or to a housing of the electric motor. The angular position instrument may comprise a sensor that senses the spatially distinctive properties of the angular position encoder, a transducer that converts the physical response of the sensor to an electrical signal and conditions this signal, and a transmitter that amplifies and transmits the amplified signal. In an embodiment, the transmitter may modulate the signal onto a carrier signal, for example into a power line communication (PLC) signal. In an embodiment, the transmitter may digitize an analog signal produced by the transducer. The transmitter may transmit an angular position signal to an electric motor controller at a surface proximate the wellbore or to a relay that may interrupt power supply to the electric motor.

As described further hereinafter, in an embodiment, the angular position encoder comprises a plurality of metal lugs disposed at equal angular offsets from each other around the encoder, where each metal lug extends a different radial distance from a hub of the encoder. In this embodiment, it is the different extensions of the metal lugs from the hub of the encoder that provides the spatially distinctive properties of the encoder. The transducer generates a signal whose amplitude reflects how close the metal of the angular position encoder is to the sensor. Said in other words, the transducer signal constitutes a signature that is characteristic of the angular position of the angular position encoder. Thus, the transducer signal associated with maximum alignment with a metal lug can be associated uniquely to one of the metal lugs and hence identify an angular position of the rotor. The transmitter can convert this transducer signal into an output signal that can be transmitted over a distance to another component that takes action based on the indication of angular position of the rotor.

As described further hereinafter, in another embodiment, the angular position encoder comprises a circular disk that is provided with permanent magnets disposed in a pattern on a surface of the disk facing the sensors of the angular position instrument. In this embodiment, it is the different locations of permanent magnets that provides the spatially distinctive properties of the encoder. The transducer generates a signal whose amplitude reflects the presence or absence of a permanent magnet proximate to (e.g., within detection distance of) one or more sensors of the angular position instrument. The transducer signal can be used to identify the angular position of the rotor. Said in other words, the output signal constitutes a signature that is characteristic of the angular position of the angular position encoder. The transmitter can convert this transducer signal into an output signal that can be transmitted over a distance to another component that takes action based on the indication of angular position of the rotor.

In some cases, it may be sufficient to determine that the rotor is turning when start-up electric power is supplied to the electric motor. If the rotor is not turning, electric power can be removed from the electric motor, the electric motor can be pulsed with electric power, and the start-up initiation may be resumed. To determine whether the rotor is turning or not, a series of angular positions of the rotor output by the angular position instrument at different times (e.g., at periodic intervals such as every millisecond, every 100 microseconds, every 10 microseconds, or some other periodic interval between 1 microsecond and 100 milliseconds) can be analyzed. If the angular position is changing in a way indicating rotation, the rotor is turning. Otherwise, the rotor is not turning. In another embodiment, it may be possible to infer rotation from generation of voltage by an electric generator function of the electric motor. In an embodiment, a small permanent magnet rotor may be coupled to the drive shaft and a small stator retained within the housing of the electric motor may be disposed around the small rotor. The small stator has windings that are not coupled to the windings of the conventional stator windings of the electric motor (e.g., the stator windings that provide the rotational output power of the electric motor). If the drive shaft is turning, the small rotor will rotate in the small stator, and the stator windings of this small stator will generate a voltage that may be transmitted to the surface. If the drive shaft is not turning, no voltage will be generated by the windings of the small stator

In yet another embodiment, during start-up, an electric motor controller located at the surface may temporarily stimulate the electric motor with electric power in only two phases of three-phase windings of the stator and sense the output of the remaining phase. If the rotor of the electric motor is turning, a voltage will be generated on the remaining phase of the three-phase windings of the stator. Having confirmed that the rotor is rotating, the electric motor controller can restore power to the remaining phase of the three-phase windings of the stator, thereafter providing conventional three-phase start-up electric power to the electric motor.

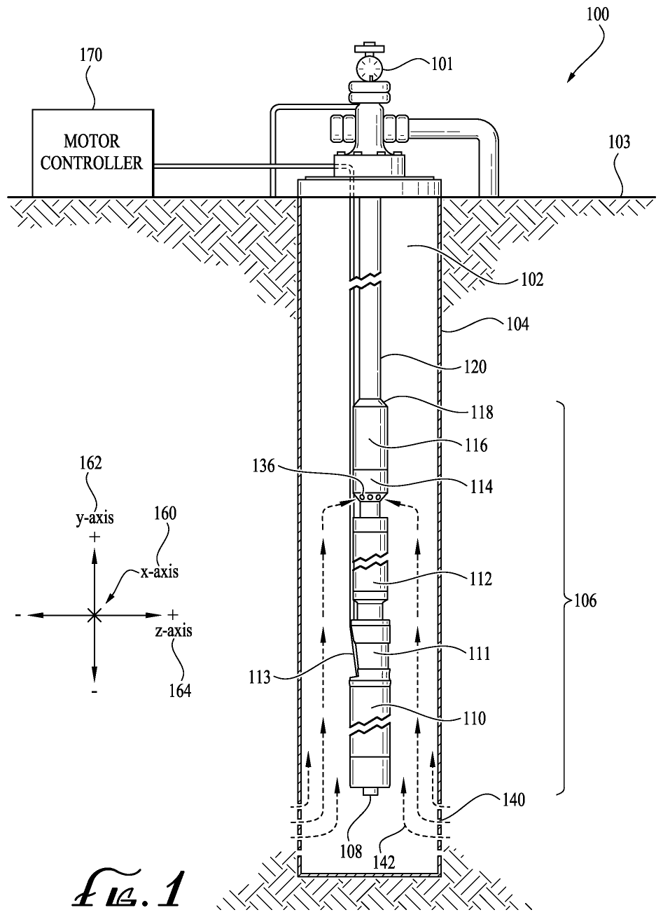

Turning now to FIG. 1 a well site environment 100 showing a completion string disposed in a wellbore, according to one or more aspects of the disclosure, is described. The well site environment 100 comprises a wellbore 102 that is at least partially cased with casing 104. As depicted in FIG. 1, the wellbore 102 is substantially vertical, but the electric submersible pump (ESP) assembly 106 described herein also may be used in a wellbore 102 that has a deviated or horizontal portion. The well site environment 100 may be at an on-shore location or at an off-shore location. The ESP assembly 106 in an embodiment comprises an optional sensor package 108, an electric motor 110, a motor head 111 that couples the electric motor 110 to a seal section 112, a fluid intake 114 having inlet ports 136, and a pump assembly 116. In an embodiment, the electric motor 110 is a permanent magnet electric submersible motor (PMESM). In a different embodiment, the electric motor 110 is an AC induction electric motor. In an embodiment, the pump assembly 116 is a centrifugal pump assembly that comprises a plurality of centrifugal pump stages. Each centrifugal pump stage may comprise an impeller mechanically coupled to a drive shaft of the centrifugal pump and a diffuser retained by a housing of the centrifugal pump in a static position. Alternatively, the pump assembly 116 may utilize a different pump mechanism, for example a progressive cavity pump (PCP) mechanism.

In an embodiment, the ESP assembly 106 may further comprise a gas separator assembly that may be located between the fluid intake 114 and the pump assembly 116. In an embodiment, the fluid intake 114 may be integrated into a downhole end of the optional gas separator. In an embodiment, the fluid intake 114 may be integrated into a downhole end of the pump assembly 116. The pump assembly 116 may couple to a production tubing 120 via a connector 118. The casing 104 and/or wellbore 102 may have perforations 140 that allow well fluid 142 to pass from the subterranean formation through the perforations 140 and into the wellbore 102. In some contexts, well fluid 142 may be referred to as reservoir fluid.

An electric cable 113 may attach to the electric motor 110 (e.g., via the motor head 111) and extend to the surface 103 to connect to an electric power source, for example to an electric motor controller 170. The electric motor controller 170 may be referred to as a variable frequency drive (VFD) or as a variable speed drive (VSD). The electric motor controller 170 may receive an angular position value from an angular position instrument disposed in the ESP assembly 106 (e.g., in the electric motor 110 or elsewhere) via the electric cable 113 or via a separate signal path. The angular position value can indicate, directly or indirectly, an angular position of a rotor of the electric motor 110. If the angular position value indicates the rotor is located in an undesirable position for start-up of the electric motor 110, the electric motor controller 170 can take appropriate action.

For example, the electric motor controller 170 may provide a short duration electric power burst or pulse to the electric motor 110, whereby to prompt the rotor of the electric motor 110 to move to a more desirable position for start-up. The electric motor controller 170 can repeatedly pulse electric power to the electric motor 110 until the rotor of the electric motor 110 is in a desirable position for start-up, based on receiving the indication of angular position of the rotor from the angular position instrument. Once the rotor of the electric motor 110 is in a desirable position for start-up, the electric motor controller 170 can perform a motor start-up process, which may involve a gentle ramping up of electric power supplied from the electric motor controller 170 via the electric cable 113 to the electric motor 110, whereby to gently accelerate the electric motor 110 and the pump assembly 116 without creating excess mechanical stress on drive shafts and/or components of the ESP assembly 106.

It will be appreciated that in a different embodiment, the configuration of the ESP assembly 106 may be different. For example, in a bottom-intake design, the fluid intake 114 may be located at the downhole end of the ESP assembly 106, the pump assembly 116 may be located uphole of the fluid intake 114, the motor 110 may be located uphole of the pump assembly 116, and the seal section 112 may be located uphole of the motor 110. For example, in a through-tubing-conveyed completion, the order of placement of components of the ESP assembly 106 may be altered in various ways, for example with the fluid intake located at the downhole end of the ESP assembly 106, the pump assembly 116 located uphole of the fluid intake 114, the seal section 112 located uphole of the pump assembly 116, and the motor 110 located uphole of the seal section 112.

The well fluid 142 may flow uphole in the wellbore 102 towards the ESP assembly 106, in the inlet ports 136, and into the fluid intake 114. The well fluid 142 may comprise a liquid phase fluid. The well fluid 142 may comprise a gas phase fluid mixed with a liquid phase fluid. The well fluid 142 may comprise only a gas phase fluid (e.g., simply gas). Over time, the gas-to-fluid ratio of the well fluid 142 may change dramatically. For example, in the circumstance of a horizontal or deviated wellbore, gas may build up in high points in the roof of the wellbore and after accumulating sufficiently may “burp” out of these high points and flow downstream to the ESP assembly 106 as what is commonly referred to as a gas slug. Thus, immediately before a gas slug arrives at the ESP assembly 106, the gas-to-fluid ratio of the well fluid 142 may be very low (e.g., the well fluid 142 at the ESP assembly 106 is mostly liquid phase fluid); when the gas slug arrives at the ESP assembly 106, the gas-to-fluid ratio is very high (e.g., the well fluid 142 at the ESP assembly 106 is entirely or almost entirely gas phase fluid); and after the gas slug has passed the ESP assembly 106, the gas-to-fluid ratio may again be very low (e.g., the well fluid 142 at the ESP assembly 106 is mostly liquid phase fluid).

Under normal operating conditions (e.g., well fluid 142 is flowing out of the perforations 140, the ESP assembly 106 is energized by electric power, the electric motor 110 is turning, and a gas slug is not present at the ESP assembly 106), the well fluid 142 enters the inlet ports 136 of the fluid intake 114, flows into the pump assembly 116, and the pump assembly 116 flows the fluid through the connector 118 and up the production tubing 120 to a wellhead 101 at the surface 103. The pump assembly 116 provides pumping pressure or pump head to lift the well fluid 142 to the surface. The well fluid 142 may comprise hydrocarbons such as crude oil and/or natural gas. The well fluid 142 may comprise water. In a geothermal application, the well fluid 142 may comprise hot water. An orientation of the wellbore 102 and the ESP assembly 106 is illustrated in FIG. 1 by an x-axis 160, a y-axis 162, and a z-axis 164.

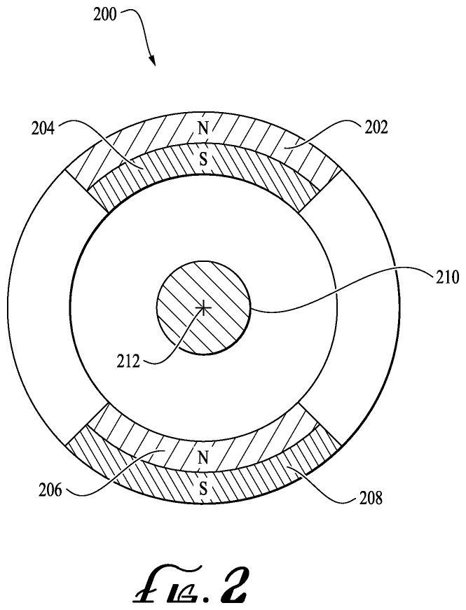

Turning now to FIG. 2, a rotor 200 of the electric motor 110 according to an embodiment of the disclosure is described. The view of FIG. 2 can be considered to be looking down on the rotor 200 along a centerline 212 or looking up on the rotor 200 along the centerline 212. The rotor 200 provides a two-pole permanent magnet rotor. The rotor 200 comprises a first permanent magnet having a first north pole magnet portion 202 and a first south pole magnet portion 204 and a second permanent magnet having a second north pole magnet portion 206 and a second south pole magnet portion 208. As illustrated in FIG. 2, the first north pole magnet portion 202 faces outwards (e.g., radially away from a centerline 212 of the rotor 200), and the first south pole magnet portion 204 faces inwards (e.g., radially towards the centerline 212). As illustrated in FIG. 2, the second north pole magnet portion 206 faces inwards, (e.g., radially towards the centerline 212), and the second south pole magnet portion 208 faces outwards (e.g., radially away from the centerline 212). It will be appreciated that in different embodiments, the rotor 200 may have a different configuration. For example, the rotor 200 may have four permanent magnets, each comprising a north pole magnet portion and a south pole magnet portion, and may provide a four-pole permanent magnet rotor. The number of poles provided by the rotor 200 desirably matches the number of poles provided by a stator of the electric motor 110.

In an embodiment, the permanent magnets are rare earth permanent magnets. In an embodiment, the permanent magnets are samarium-cobalt rare earth permanent magnets. In an embodiment, the permanent magnets are neodymium rare earth permanent magnets. Samarium-cobalt rare earth permanent magnets may retain desirable magnetic properties better than neodymium rare earth permanent magnets in a high temperature downhole environment. Neodymium rare earth permanent magnets may provide higher magnetic force than samarium-cobalt rare earth permanent magnets when they are used in a moderate temperature downhole environment. The permanent magnets produce a substantially constant magnetic field strength and may be referred to as passive magnets in contrast to other magnetic devices (e.g., an electro magnet) that may produce a controllable magnetic field strength. The field strength of permanent magnets, however, may slowly decline over extended periods of time. For example, permanent magnets may lose about 1% of their field strength over a period of 100 years. Permanent magnets can lose field strength more rapidly when subjected to high temperatures. Permanent magnets can lose field strength when subjected to mechanical shocks and impacts. The permanent magnets may be fixed in place on or in the rotor 200 and can further be distinguished from permanent magnets whose position may be dynamically controlled by a feedback control loop type of control system.

The rotor 200 is mechanically coupled to a drive shaft 210 of the electric motor 110. The rotor 200 may be coupled to the drive shaft 210 by inserting a key into a keyway in an outside surface of the drive shaft 210 and a keyway in an inside surface of the rotor 200. As the rotor 200 turns (e.g., driven by interaction between magnetic fields of the permanent magnets in the rotor 200 and magnetic fields induced by varying electric current in windings of a stator of the electric motor 110), the drive shaft 210 turns. The drive shaft 210 may be coupled to a second drive shaft in the seal section 112; and the second drive shaft may be coupled to a third drive shaft in the pump assembly 116. Thus, when the drive shaft 210 turns, the third drive shaft in the pump assembly 116 may turn, causing pump structures inside the pump assembly 116 to lift well fluid 142 up the production tubing 120 to the surface 103.

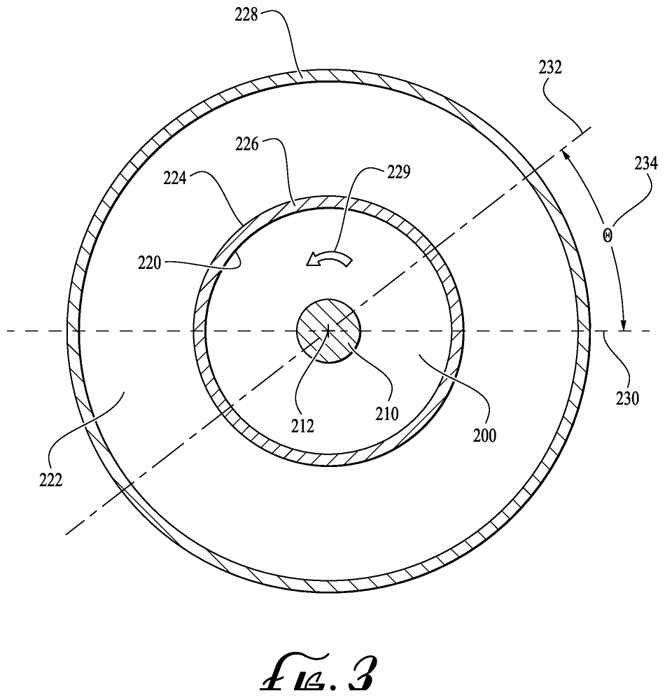

Turning now to FIG. 3, a cross-section view of the electric motor 110 is described. The view of FIG. 3 can be considered to be looking down on the electric motor 110 along the centerline 212 or looking up on the electric motor 110 along the centerline 212. While the direction of rotation 229 of the rotor 200 is illustrated as being counterclockwise in FIG. 3, in another embodiment, the rotor 200 could rotate in the clockwise sense. The electric motor 110 comprises the rotor 200 and a stator 222. An outside surface 220 of the rotor 200 is separated from an inside surface 224 of the stator 200 by an air gap 226. The air gap 226 is desirably small in dimension whereby to promote more efficient interactions between the rotor 200 and the stator 222. The stator 222 is retained within a housing 228 of the electric motor 110. In a preferred embodiment, the rotor 200 is configured as a permanent magnet rotor, but it will be appreciated that the teachings of the present disclosure may also be applied advantageously to electric motors 110 that comprise an induction rotor (e.g., a rotor having a squirrel cage and two end caps that are often seen in a conventional AC induction electric motor). In this case, the electric motor may be referred to as an AC induction electric motor. The stator 222 comprises windings that receive electric power via the electric cable 113 from the electric motor controller 170 located at the surface 103. In an embodiment, the stator 222 comprises three-phase windings.

A first reference line 230 may be defined relative to the stator 222, and a second reference line 232 may be defined relative to the rotor 200. An angular position θ (theta) 234 represents the angular separation between the first reference line 230 and the second reference line 232. The angular position θ 234 can be represented in any suitable angular unit such as degrees, radians, or some other angular unit. As the rotor 200 turns in the direction 229, the angular position θ 234 increases from 0 degrees (alternatively, 0 radians) to 180 degrees (π radians), to 270 degrees (3/2 π radians), to 360 degrees (2 π radians), which is the same as 0 degrees. As the rotor 200 continues to turn in the direction 229, the angular position θ 234 cycles through the range of 0 to 360 degrees (alternatively, 0 radians to 2 π radians).

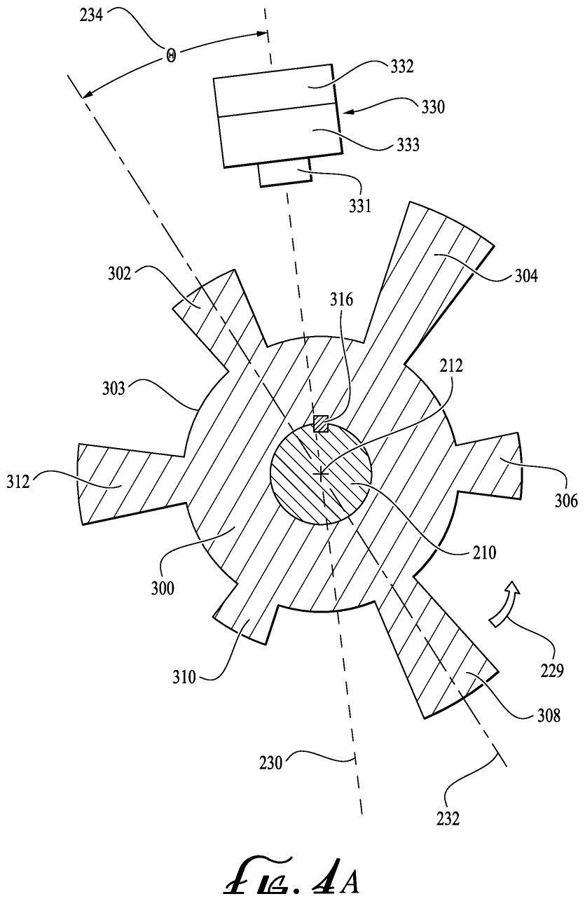

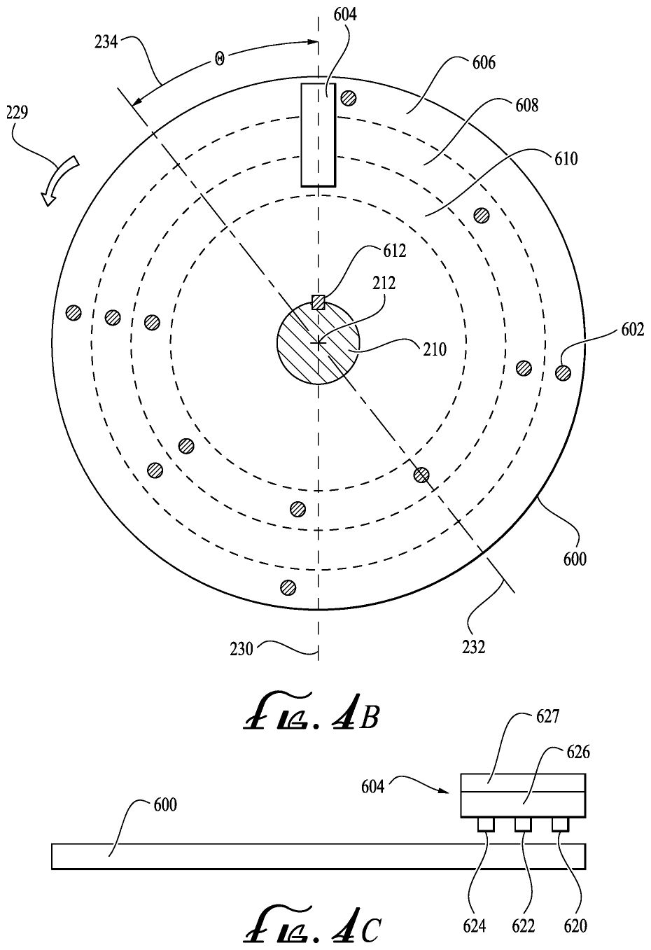

Turning now to FIG. 4A, an angular position encoder 300 and an angular position instrument 330 are described. The angular position encoder 300 and the angular position instrument 330 together may be considered to form an angular position detector or an angular position detection system. In an embodiment, the angular position encoder 300 comprises a plurality of metal lugs disposed in about the same plane perpendicular to the centerline 212 of the rotor 200 and of the electric motor 110, for example a first metal lug 302, a second metal lug 304, a third metal lug 306, a fourth metal lug 308, a fifth metal lug 310, and a sixth metal lug 312. It will be appreciated that the angular position encoder 300 may comprise any number of metal lugs, for example three metal lugs, four metal lugs, five metal lugs, seven metal lugs, eight metal lugs, nine metal lugs, ten metal lugs, twelve metal lugs, sixteen metal lugs, eighteen metal lugs, or some other number of metal lugs less than ten thousand metal lugs. Between each metal lug the angular position encoder 300 defines a hub 303 that is generally concentric with the centerline axis 212 (excepting where the metal lugs protrude radially outwards from the hub 303). In some contexts, the metal lugs may referred to as metal teeth.

In an embodiment, the angular position encoder 300 is an integrated structure, where the metal lugs and the hub 303 are formed out of a contiguous piece of metal. The angular position encoder 300 may be machined out of an originally substantially flat metal disk. The angular position encoder 300 may be cast from molten metal and finished. The angular position encoder 300 may sintered together from metal powder subjected to high pressure and heat. The angular position encoder 300 may be made in a 3-D metal printing process. In an embodiment, the angular position encoder 300 may be made out of a ferrous metal material. Alternatively, in an embodiment, the angular position encoder 300 may be made out of a non-ferrous metal material. In an embodiment, the angular position encoder 300 is not formed out of a contiguous piece of metal, the hub 303 is made of a first kind of metal, and the metal lugs are each formed of a different second kind of metal. In this case, the metal lugs may be joined to the hub 303 by welding and/or by dove-tail friction fit joints.

Each metal lug has an outer edge that is the part of the lug located furthest away from the centerline axis 212 and two sides that extend from the hub 303 to the outer edge of the given metal lug. While the metal lugs shown in FIG. 4A are represented as having two sides that, if they were extended, would converge on the centerline 212 of the drive shaft 212, in an embodiment the two sides of each metal lug may be parallel or angle so as to converge, if they were extended, at a point distant from the centerline axis 212.

The angular position instrument 330 may be retained in a static angular position by the stator 222 or by the housing 228 of the electric motor 110. In an embodiment, the angular position instrument 330 may be attached to a mounting bracket, and the mounting bracket may be attached to the stator 222 or to the housing 228. The angular position instrument 330 can be located in the plane of the angular position encoder 300, aiming its sensing capability parallel to the plane of the angular position encoder 300 and towards the centerline axis 212. In an embodiment, the angular position instrument 330 comprises a sensor 331, a transducer 333, and a transmitter 332. In an embodiment, the sensor 331 and/or the transducer 333 comprises a Hall effect sensor. In an embodiment, the sensor 331 and/or the transducer 333 comprises a magnetic pick-up. The sensor 331, the transducer 333, and the transmitter 332 may be enclosed in a sealed housing to protect them from the dielectric oil that is disposed within the electric motor 110 and/or from other fluids inside the ESP assembly 106. It will be appreciated that, in one or more embodiments, the sensor 331 and transducer 333 may be integrated as a single component; the transducer 333 and the transmitter 332 may be integrated as a single component; or the sensor 331, the transducer 333, and the transmitter 332 may be integrated as a single component.

The angular position instrument 330 can detect whether a metal lug is angularly aligned with the sensor 330 or whether the hub 303 is angularly aligned with the sensor 330. Further, the angular position instrument 330 is able to distinguish between the different metal lugs based on the different distances each different metal lug extends from the hub 303. For example, second metal lug 304 has an outer edge that extends about seven units from the hub 303, fourth metal lug 308 has an outer edge that extends about six units from the hub 303, sixth metal lug 312 has an outer edge that extends about five units from the hub 303, first metal lug 302 has an outer edge that extends about four units from the hub 303, third metal lug 306 has an outer edge that extends about three units from the hub 303, and fifth metal lug 310 has an outer edge that extends about two units from the hub 303. The units referred to are proportional and are not meant to equate to a specific distance. The variation in the distances the outer edges of the metal lugs extend from the hub 303 can be determined based on the sensitivity of sensor 331 and/or of the angular position instrument 330. In an embodiment, it is desirable to have differences of extensions of the outer edges of the metal lugs from the hub 303 at a minimum that is still sufficient to allow the angular position instrument 330 to reliably distinguish between the different metal lugs. Minimizing the differences of extensions of the outer edges of the metal lugs from the hub 303 may improve rotational balance of the angular position encoder 300 as it rotates rapidly with the drive shaft 210.

As one of the metal lugs passes in front of the sensor 331, the angular position instrument 330 can identify which metal lug is passing and can map this identity to an angular position θ 234 associated with that particular metal lug and transmit this value of angular position θ 234 to another component (e.g., the electric motor controller 170). The transducer 333 and/or the transmitter 332 may filter the indications from the sensor 331 and/or amplify the indications. The transmitter 332 may digitize the indication of angular position θ 234 and/or modulate the indication onto a carrier frequency before transmitting via the electric cable 113, for example as a PLC signal. In an embodiment, the angular position instrument 330 sends a signal that provides an indication of the angular position e 234 of the rotor 200, and the electric motor controller 170, or other intelligent component, maps this signal to a value of the angular position θ 234.

As illustrated in FIG. 4A, the first metal lug 302 is associated with 0 degrees between the second reference line 232 and the first reference line 230; the second metal lug 304 is associated with 60 degrees between the second reference line 232 and the first reference line 230; the third metal lug 306 is associated with 120 degrees between the second reference line 232 and the first reference line 230; the fourth metal lug 308 is associated with 180 degrees between the second reference line 232 and the first reference line 230; the fifth metal lug 310 is associated with 240 degrees between the second reference line 232 and the first reference line 230; the sixth metal lug 304 is associated with 300 degrees between the second reference line 232 and the first reference line 230. In this way, the angular position instrument 330 can positively and uniquely identify the angular position of the rotor 200. The angular position instrument 330 can send this information via the electric cable 113 up to the surface and to the electric motor controller 170.

It will be noted that the metal lugs 302, 304, 306, 308, 310, 312 are disposed, in most cases (first metal lug 302 and sixth metal lug 312 are an exception and only differ from each other by one unit), to enhance a contrast in distance from the hub 303 between adjacent metal lugs, whereby to enhance the ability to distinguish between the metal lugs and to reliably identify which metal lug is being detected. This arrangement may be referred to as staggering the different extensions of adjacent metal lugs from the hub 303. In an embodiment, the metal lugs are disposed about the hub 303 to both establish a centroid of mass of the angular position encoder 300 that coincides with the centerline 212 and to enhance distinction between adjacent metal lugs. As indicated above, in an embodiment, the hub 303 may be formed of a first kind of metal material and the metal lugs may be formed of a different second kind of material. The first kind of metal material may be selected to be less readily sensed by the sensor 331 and/or the angular position instrument 330 and the second kind of metal material may be selected to be more readily sensed by the sensor 331 and/or the angular position instrument 330. The use of two different metal materials in this way may further assist the angular position instrument 330 in distinguishing between different metal lugs and thereby to better identify the angular position θ 234 of the angular position encoder 300 and thus to identify the angular position of the rotor 200.

In an embodiment, the angular position encoder 300 may have a pattern of metal lugs that is unique over an angular position of 0 to 180 degrees but then is repeated over the angular position from 180 degrees to 360 degrees. In this case, a second angular position encoder may be coupled to the drive shaft 210, axially offset from the angular position encoder 300. The angular position instrument 330, in this embodiment, may comprise a second sensor that aligns with the second angular position encoder. In this case, the outputs of the sensor 331 and the second sensor can be combined by the transducer 333 and/or by the transmitter 332 to uniquely identify the angular position θ 234 of the rotor 200 based on the signature received by the sensor 331 combined with the signature received by the second sensor. In an embodiment, the angular position instrument 330 may comprise a single transducer 333 that processes signals from multiple sensors 331 concurrently. In another embodiment, the angular position instrument 330 may comprise a plurality of transducers 333 (e.g., one transducer 333 for each sensor), and a single transmitter 332 may process the multiple transducer outputs to generate the angular position signal.

In an embodiment, a first angular position encoder may comprise N-number of different sized metal lugs that are repeated M-number of times around the first angular position encoder; and a second angular position encoder may comprise M-number of different sized metal lugs disposed around the second angular position encoder with no repetitions. This arrangement could encode N×M different angular positions around the drive shaft 210. This approach of using two or more angular position encoders in combination could provide benefits for making the angular position encoders, in aggregate, more balanced in rotation and/or for providing more robust and reliable determination of angular position of the drive shaft 210.

While the description above indicates that the angular position encoder 300 and the angular position instrument 330 are disposed within the electric motor 110, in other embodiments the encoder 300 and angular position instrument 330 may be disposed at different locations within the ESP assembly 106, for example in the sensor 108, in the seal section 112, in an optional gas separator assembly, or in the pump assembly 116. In an embodiment, multiple encoder 300/instrument 330 pairs may be disposed at different locations within the ESP assembly 106. In this case, if a drive shaft within the ESP assembly 106 breaks, the precise location of the broken drive shaft can be determined.

The angular position signal transmitted by the angular position instrument 330 can be analyzed by the electric motor controller 170 (or by another intelligent component in communication with the electric motor controller 170) to determine a time-sequence of angular positions θ 234 of the rotor 200. The electric motor controller 170 can then analyze this sequence of angular positions θ 234 to determine if the rotor 200 is turning, if the rotor 200 is not turning, or if the rotor 200 is cogging (e.g., jumping clockwise and counterclockwise within a narrow angular position range of less than 120 degrees). Based on this analysis, the electric motor controller 170 can take appropriate action, for example continue normal start-up sequence or stop the normal start-up sequence. If the normal start-up sequence is stopped, the electric motor controller 170 may pulse electric power to the electric motor 110 one or more times in succession to attempt to locate the rotor 200 in a favorable position for initiating a start-up sequence. In this process, the electric motor controller 170 may take note to the angular position θ 234 after each instance of pulsing electric power to the electric motor 110 to determine if the rotor 200 is in a favorable position or not. If the rotor 200 is in a favorable position, the electric motor controller 170 can halt further pulsing of electric power and initiate start-up procedure. If the rotor 200 remains in an unfavorable position, the electric motor controller 170 may repeat the pulsing of electric power to the electric motor 110.

If a number of attempts have been made to pulse the electric motor 110 into a favorable position but have failed or if a start-up was attempted but aborted because the rotor 200 was not detected to be moving, a serious problem may exist in the ESP 106. In this circumstance it may be desirable to give up further attempts to start the electric motor 110 and to pull the ESP assembly 106 out of the wellbore 102 to positively identify the source of the problem and to fix that problem rather than damage the electric motor 110 or other parts of the ESP assembly 106. For example, the pump assembly 116 may be clogged with sand such as to defeat attempts to start the electric motor 110. In this case, attempts to start the electric motor 110 are hopeless and persisting in starting the electric motor 110 can cause damage to the electric motor 110, breakage of drive shafts, and/or damage to the pump assembly 116. One of the benefits of the angular position encoder 300 and angular position instrument 330 (as well as of the angular position encoder 600 and angular position instrument 604 described below with reference to FIG. 4B and FIG. 4C) is to detect such a stuck condition and to avoid damaging the ESP assembly 106 needlessly.

Turning now to FIG. 4B and FIG. 4C, an angular position encoder 600 and an angular position instrument 604 are described. The angular position encoder 600 and the angular position instrument 604 together may be considered to form an angular position detector or an angular position detection system. In an embodiment, the angular position encoder 600 has the general form of a flat, circular metal disk and comprises a plurality of permanent magnets 602 installed in or proximate a surface of the disk. The permanent magnets may be formed of any of the permanent magnet materials described above with reference to FIG. 2. In an embodiment, the permanent magnets 602 may be disposed under a surface coating that protects the permanent magnets 602 from exposure to dielectric oil and/or wellbore fluids. While FIG. 4B illustrates the angular position encoder 600 as having twelve permanent magnets 602, in different embodiments different numbers of permanent magnets 602 may be employed. The angular position encoder 600 may be mechanically coupled to the drive shaft 210 and rotate with the drive shaft 210 as it turns (and as the rotor 200 turns). In an embodiment, a key 612 mates with a keyway in the angular position encoder 600 and in a keyway in an outside surface of the drive shaft 210. In an embodiment, the angular position instrument 604 is located in a fixed position affixed to the stator 222 and/or to the housing 228 of the electric motor 110. In an embodiment, the angular position instrument 604 may be attached to a mounting bracket, and the mounting bracket may be attached to the stator 222 or to the housing 228. The angular position instrument 604 can detect when permanent magnets 602 pass close to the angular position instrument 604 and can map this detection to the angular position θ 234 of the rotor 200.

In an embodiment, the permanent magnets 602 are disposed in one of a plurality of circular tracks on the angular position encoder 600, for example in a first track 606, in a second track 608, or in a third track 610. In another embodiment, the permanent magnets 602 may be disposed in a different number of circular tracks, for example in two circular tracks, four circular tracks, five circular tracks, six circular tracks, seven circular tracks, eight circular tracks, or some other number of circular tracks less than sixty-five circular tracks. The tracks 606, 608, 610 are not actual physical features of the angular position encoder 600 but simply delineate for illustration purposes where permanent magnets 602 may be placed on the angular position encoder 600. The permanent magnets 602 may be located at specific angular positions in the circular tracks 606, 608, 610 relative to the second reference line 232.

As illustrated in FIG. 4B, the permanent magnets 602 are located at 0 degrees plus or minus 15 degrees, 45 degrees plus or minus 15 degrees, 90 degrees plus or minus 15 degrees, 135 degrees plus or minus 15 degrees, 180 degrees plus or minus 15 degrees, 225 degrees plus or minus 15 degrees, 270 degrees plus or minus 15 degrees, and 315 degrees plus or minus 15 degrees relative to the second reference line 232. In another embodiment, however, the permanent magnets 602 may be located at different regularly spaced angular distances. In an embodiment, the permanent magnets 602 may be spaced every 180 degrees apart plus or minus 30 degrees, every 120 degrees apart plus or minus 30 degrees, every 90 degrees apart plus or minus 20 degrees, every 60 degrees apart plus or minus 20 degrees, every 30 degrees apart plus or minus 10 degrees, every 20 degrees apart plus or minus 5 degrees, every 10 degrees apart plus or minus 3 degrees, every 5 degrees apart plus or minus 1 degree, or some other number of degrees apart greater than 0.5 degrees.

In an embodiment, the angular position instrument 604 comprises a first sensor 620 that aligns with or is directed towards the first track 606, a second sensor 622 that aligns with or is directed towards the second track 608, a third sensor 624 that aligns with or is directed towards the third track 610, a transducer 626, and a transmitter 627. The sensors 620, 622, 624, the transducer 626, and the transmitter 627 may be enclosed in a sealed housing to protect them from the dielectric oil that is disposed within the electric motor 110 and/or from other fluids inside the ESP assembly 106. In an embodiment, the sensors 620, 622, 624 and the transducer 626 may be integrated in a single component; the transducer 626 and the transmitter 627 may be integrated in a single component; or the sensors 620, 622, 624, the transducer 626, and the transmitter 127 may be integrated in a single component.

The transmitter 627 may transmit an angular position signal that indicates the angular position θ 234 via the electric cable 113 to the electric motor controller 170 or to other components in the ESP assembly 106. The transducer 626 and/or transmitter 627 may filter the indications it receives from the sensors 620, 622, 624 and/or amplify a signal that encodes the indication of the angular position θ 234 before transmitting via the electric cable 113. The transmitter 627 may digitize the signal and/or modulate the signal onto a carrier frequency before transmitting via the electric cable 113, for example as a PLC signal.

As a permanent magnet 602 disposed in the first track 606 passes proximate to the first sensor 620, the first sensor 620 may indicate the presence of the permanent magnet 602 with a first signal amplitude that it provides to the transducer 626 and when no permanent magnet 602 is proximate the first sensor 620, the first sensor 620 may indicate the absence of any permanent magnet 602 with a second signal amplitude (or a zero amplitude signal) that it provides to the transducer 626. The second sensor 622 and the third sensor 624 can likewise detect presence of permanent magnets 602 and provide signals to the transducer 626 in like manner.

A binary value can be assigned (e.g., by the transducer 626 and/or by the transmitter 627) to the signals generated by each sensor 620, 622, 624—either a ‘0’ value when no permanent magnet 602 is detected or a ‘1’ value when a permanent magnet 602 is detected (the assignment of these binary values can be reversed in an alternative embodiment, so a ‘0’ value associates to detection of a permanent magnet 602 and a ‘1’ value associates to non-detection of a permanent magnet 602). As an example, permanent magnets can be disposed at fixed angle positions and in particular tracks 606, 608, 610 to encode angular positions e 234 of the rotor 200 relative to the first reference line 230 as indicated in Table 1 below:

TABLE 1

| Angular | 3^{rd} | 2^{nd} | 1^{st} |
|---|---|---|---|
| Position | Transducer | Transducer | Transducer |
| 0° | 0 | 0 | 0 |
| 45° | 0 | 0 | 1 |
| 90° | 0 | 1 | 0 |
| 135° | 0 | 1 | 1 |
| 180° | 1 | 0 | 0 |
| 225° | 1 | 0 | 1 |
| 270° | 1 | 1 | 0 |
| 315° | 1 | 1 | 1 |

It will be appreciated that in different embodiments, different numbers of tracks 606, 608, 610 and different numbers of permanent magnets 602 may be placed at different angular positions to establish a desired resolution of angular position sensing by the angular location encoder 600 and angular position instrument 604.

In an embodiment, the electric motor 110 may comprise both angular position encoders 300 associated with angular position instruments 330 and angular position encoders 600 associated with angular position instruments 604, whereby to generate redundant indications of the angular position θ 234 of the rotor 200. In an embodiment, rather than being located in the electric motor 110, the angular position encoder 600 and angular position instrument 604 may be located in other components of the ESP assembly 106. In an embodiment, the angular position encoder 600 and angular position instrument 604 may be located both in the electric motor and in one or more other of the seal section 112 and the pump assembly 116.

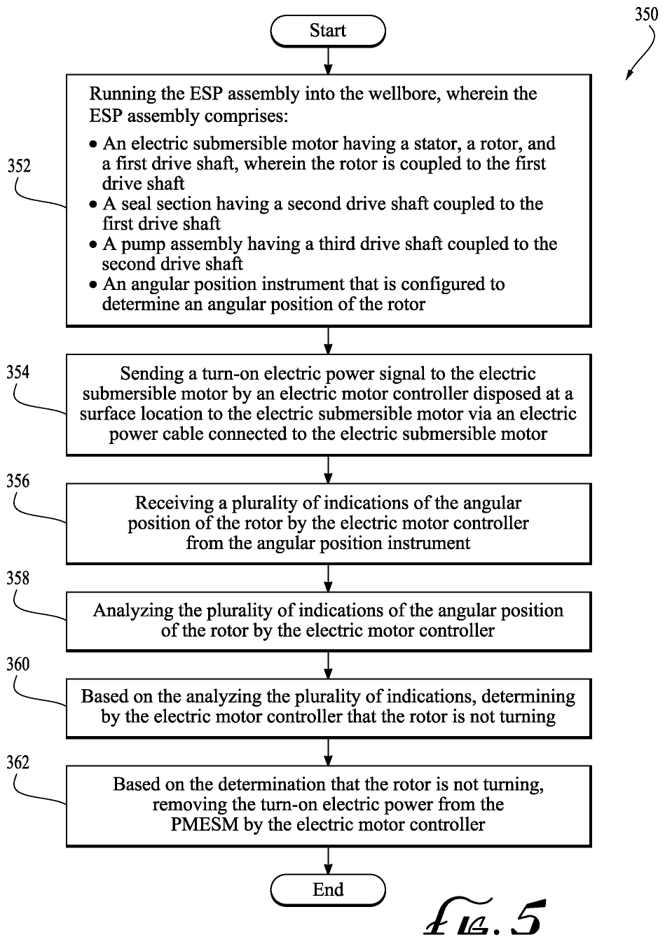

Turning now to FIG. 5, a method 350 is described. In an embodiment, the method 350 is a method of operating an electric submersible pump (ESP) assembly in a wellbore. At block 352, the method 350 comprises running the ESP assembly into the wellbore. In an embodiment, the ESP assembly comprises a permanent magnet electric submersible motor (PMESM) having a stator, a rotor, and a first drive shaft, wherein the rotor is coupled to the first drive shaft and comprises a plurality of permanent magnets, a seal section having a second drive shaft coupled to the first drive shaft, a pump assembly having a third drive shaft coupled to the second drive shaft, and an angular position instrument that is configured to determine an angular position of the rotor. At block 354, the method 350 comprises sending a turn-on electric power signal to the PMESM by an electric motor controller disposed at a surface location to the PMESM. In an embodiment, the turn-on electric power signal is sent via an electric power cable from the electric motor controller to the electric motor. The turn-on power signal may be an electric power level that is less than full-on electric power, for example an electric power level that gently accelerates the rotor of the PMESM to avoid unnecessary mechanical stress on components of the ESP assembly. The turn-on power signal sent by the electric motor controller may increase electric voltage and or frequency over a span of time in a series of increments to reach the full-on power level. In an embodiment, the electric motor in the ESP assembly of method 350 is not a permanent magnet motor but an AC induction motor having a rotor with a inductive squirrel cage.

At block 356, the method 350 comprises receiving a plurality of indications of the angular position of the rotor by the electric motor controller from the angular position instrument. In an embodiment, the indications of the angular position of the rotor are encoded in a PLC signal and transmitted from the angular position instrument to the electric motor controller via an electric power cable that connects from the electric motor controller to the electric motor. In embodiment, the indications of the angular position of the rotor are received by the electric motor controller from the angular position instrument via the electric power cable in a form other than a PLC signal. In an embodiment, the plurality of indications of the angular position of the rotor are transmitted not on the electric power cable but on an independent wire from the angular position instrument to the surface and to the electric motor controller (or to an intermediate processor that is in communication with the electric motor controller). In an embodiment, the angular position instrument interworks with an angular position encoder having metal lugs that extend different distances from a hub of the angular position encoder (e.g., the embodiment illustrated and described with reference to FIG. 4A above). In an embodiment, the angular position instrument interworks with an angular position encoder having permanent magnet disposed in a distinctive pattern (e.g., the embodiment illustrated and described with reference to FIGS. 4B and 4C above).

In an embodiment, each of the indications of angular position of the rotor sent by the angular position instrument uniquely identifies an angular position of the rotor in the range from a 0 degrees position to a 360 degrees position. In an embodiment, the indications of angular position of the rotor sent by the angular position instrument uniquely identifies an angular position of the rotor as one of 0 degrees plus or minus 20 degrees, 60 degrees plus or minus 20 degrees, 120 degrees plus or minus 20 degrees, 180 degrees plus or minus 20 degrees, 240 degrees plus or minus 20 degrees, and 300 degrees plus or minus 20 degrees. In an embodiment, the indications of angular position of the rotor sent by the angular position instrument uniquely identifies an angular position of the rotor as one of 0 degrees plus or minus 15 degrees, 45 degrees plus or minus 15 degrees, 90 degrees plus or minus 15 degrees, 135 degrees plus or minus 15 degrees, 180 degrees plus or minus 15 degrees, 225 degrees plus or minus 15 degrees, 270 degrees plus or minus 15 degrees, and 315 degrees plus or minus 15 degrees.

In an embodiment, the indications of angular position of the rotor sent by the angular position instrument uniquely identifies an angular position of the rotor as one of 0 degrees plus or minus 10 degrees, 30 degrees plus or minus 10 degrees, 60 degrees plus or minus 10 degrees, 90 degrees plus or minus 10 degrees, 120 degrees plus or minus 10 degrees, 150 degrees plus or minus 10 degrees, 180 degrees plus or minus 10 degrees, 210 degrees plus or minus 10 degrees, 240 degrees plus or minus 10 degrees, 270 degrees plus or minus 10 degrees, 300 degrees plus or minus 10 degrees, and 330 degrees plus or minus 10 degrees. In an embodiment, the indications of angular position of the rotor sent by the angular position instrument uniquely identifies an angular position of the rotor as one of 0 degrees plus or minus 5 degrees, 20 degrees plus or minus 5 degrees, 40 degrees plus or minus 5 degrees, 60 degrees plus or minus 5 degrees, 80 degrees plus or minus 5 degrees, 100 degrees plus or minus 5 degrees, 120 degrees plus or minus 5 degrees, 140 degrees plus or minus 5 degrees, 160 degrees plus or minus 5 degrees, 180 degrees plus or minus 5 degrees, 200 degrees plus or minus 5 degrees, 220 degrees plus or minus 5 degrees, 240 degrees plus or minus 5 degrees, 260 degrees plus or minus 5 degrees, 280 degrees plus or minus 5 degrees, 300 degrees plus or minus 5 degrees, 320 degrees plus or minus 5 degrees, and 340 degrees plus or minus 5 degrees.

At block 358, the method 350 comprises analyzing the plurality of indications of the angular position of the rotor by the electric motor controller. At block 360, the method 350 comprises, based on the analyzing the plurality of indications, determining by the electric motor controller that the rotor is not turning. In an embodiment, the processing of blocks 358 and 360 are performed not by the electric motor controller but instead by an intermediate processor such as a computer system or programmable logic controller (PLC). The intermediate processor may then generate a command signal that it sends to the electric motor controller (e.g., command signals that cause the electric motor controller to remove turn-on electric power from the PMESM and/or to pulse electric power to the PMESM).

At block 362, the method 350 comprises, based on the determination that the rotor is not turning, removing the turn-on electric power from the PMESM by the electric motor controller. In an embodiment, the method 350 further comprises, in response to the determination that the rotor is not turning, sending a pulse of electric power by the electric motor controller to the PMESM.

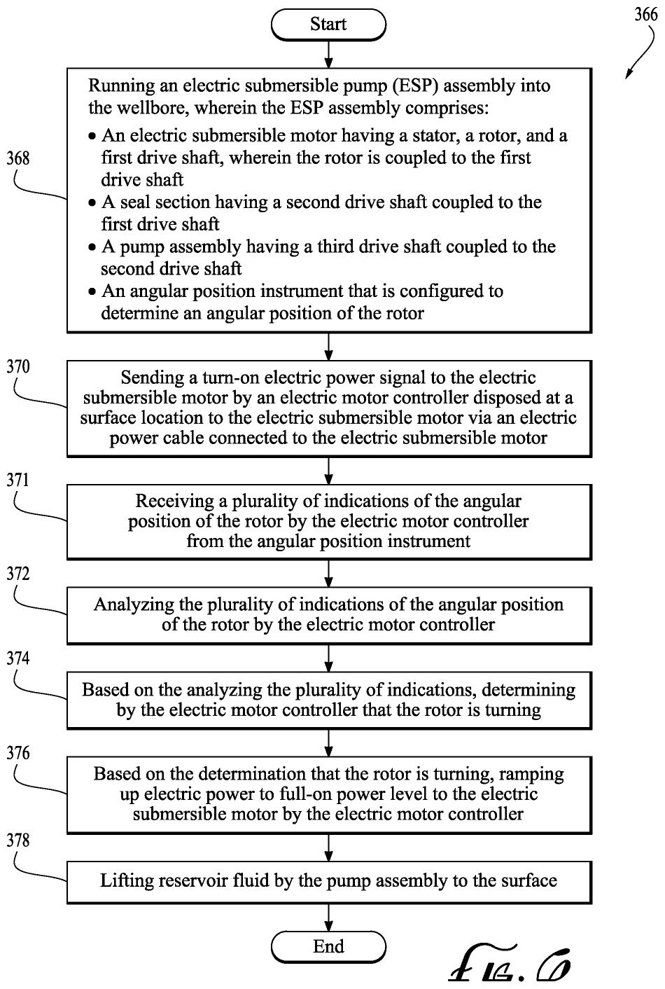

Turning now to FIG. 6, a method 366 is described. In an embodiment, the method 366 is a method of lifting fluid in a wellbore. At block 368, the method 366 comprises running an electric submersible pump (ESP) assembly into the wellbore. In an embodiment, the ESP assembly comprises a electric submersible motor having a stator, a rotor, and a first drive shaft, wherein the rotor is coupled to the first drive shaft, a seal section having a second drive shaft coupled to the first drive shaft, a pump assembly having a third drive shaft coupled to the second drive shaft, and an angular position instrument that is configured to determine an angular position of the rotor. In an embodiment, the electric submersible motor may be an AC induction motor. In an embodiment, the electric submersible motor may be a permanent magnet motor.

At block 370, the method 366 comprises sending a turn-on electric power signal to the electric submersible motor by an electric motor controller disposed at a surface location. The turn-on power signal sent by the electric motor controller may be an electric power level that is less than full-on electric power, for example an electric power level that gently accelerates the rotor of the electric submersible motor to avoid unnecessary mechanical stress on components of the ESP assembly. The turn-on power signal sent by the electric motor controller may increase electric voltage and or frequency over a span of time in a series of increments to reach the full-on power level. At block 371, the method 366 comprises receiving a plurality of indications of the angular position of the rotor by the electric motor controller from the angular position instrument. The indications of angular position may be transmitted by the angular position instrument via the electric power cable. Alternatively, the indications of angular position may be transmitted by the angular position instrument via a separate wire or wires not included in the electric power cable.

At block 372, the method 366 comprises analyzing the plurality of indications of the angular position of the rotor by the electric motor controller. At block 374, the method 366 comprises, based on the analyzing the plurality of indications, determining by the electric motor controller that the rotor is turning. In an embodiment, the processing of blocks 371, 372, 374 may be performed by another processor that is in communication with the electric motor controller and that may send control signals to the electric motor controller.

At block 376, the method 366 comprises, based on the determination that the rotor is turning, ramping up electric power to full-on power level to the electric submersible motor by the electric motor controller. At block 378, the method 366 comprises lifting reservoir fluid by the pump assembly to the surface.

In an embodiment, the ESP assembly further comprises an angular position encoder mechanically coupled to the first drive shaft, the second drive shaft, or the third drive shaft and wherein the method further comprises the angular position instrument determining the angular position of the rotor by sensing a spatially distinctive feature of the angular position encoder. In an embodiment, the angular position encoder comprises a plurality of metal lugs that extend different distances from a hub of the angular position encoder and where the spatially distinctive features of the angular position encoder comprise the different distances each of the metal lugs extends from the hub. In an embodiment, the angular position encoder comprises a plurality of permanent magnets disposed in a distinctive pattern at different angular positions on the angular position encoder and where the spatially distinctive features of the angular position encoder comprise the different dispositions of permanent magnets at different angular positions on the angular position encoder.

A method disclosed herein teaches a method of operating an electric submersible pump (ESP) assembly in a wellbore. This method comprises running the ESP assembly into the wellbore, wherein the ESP assembly comprises a permanent magnet electric submersible motor (PMESM) having a stator, a rotor, and a first drive shaft, wherein the rotor is coupled to the first drive shaft and comprises a plurality of permanent magnets, a seal section having a second drive shaft coupled to the first drive shaft, and a pump assembly having a third drive shaft coupled to the second drive shaft. In an embodiment, the ESP assembly of this method comprises not a PMESM but rather an AC induction motor. This method further comprises sending a turn-on electric power signal to the PMESM by an electric motor controller disposed at a surface location to the PMESM via an electric power cable connected to the PMESM.

This method further comprises receiving a voltage signal from the electric motor by the electric motor controller. This method further comprises analyzing the received voltage signal by the electric motor controller. This method further comprises, based on the analyzing the received voltage signal, determining by the electric motor controller that the rotor is turning. This method further comprises, based on the determination that the rotor is turning, ramping up electric power to full-on power level to the PMESM by the electric motor controller.

In an embodiment, the PMESM is a three-phase electric motor, wherein the turn-on electric power sent by the electric motor controller to the PMESM sends electric power to a first phase winding and to a second phase winding of the stator of the PMESM, and wherein the voltage signal received by the electric motor controller from the electric motor is generated in a third phase winding of the stator of the PMESM. In another embodiment, the PMESM further comprises a secondary rotor having permanent magnets and a secondary stator, wherein the voltage signal receive by the electric motor controller from the electric motor is generated in a winding of the secondary stator.

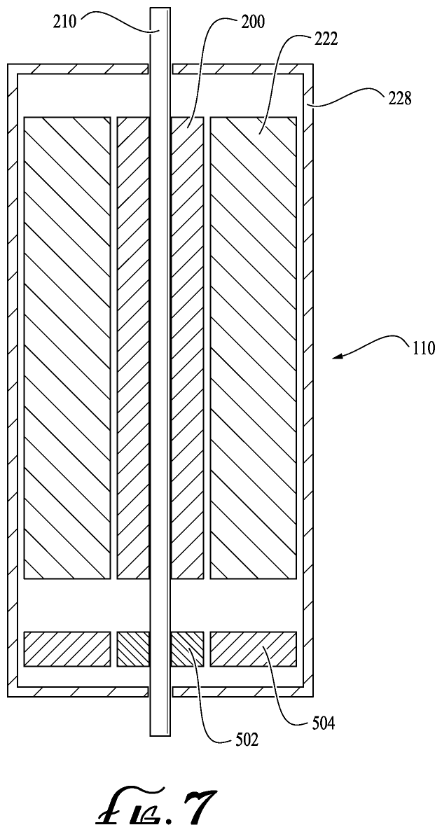

Turning now to FIG. 7, an embodiment of the electric motor 110 is described. In an embodiment, the electric motor 110 comprises the rotor 200, the stator 222, the drive shaft 210, and the housing 228 described above as well as a secondary rotor 502 and a secondary stator 504. It is noted that an electric motor 110 that comprises the angular position encoder 300 and angular position instrument 330 described above with reference to FIG. 4A and/or that comprise the angular position encoder 600 and angular position instrument 604 described above with reference to FIG. 4B and FIG. 4C (or an electric motor 110 in an ESP assembly 106 that comprises an angular position encoder and angular position instrument located in another component of the ESP assembly 106) need not include the secondary rotor 502 or the secondary stator 504. In some embodiments, however, one or both of the angular position encoders 300, 600 may be included in an electric motor 110 that also includes the secondary rotor 502 and the secondary stator 504, for example when redundant angular position indications are desired.

The secondary rotor 502 is mechanically coupled to the drive shaft 210 (e.g., using a key inserted into aligned keyways in the outside surface of the drive shaft 210 and in the inside surface of the secondary rotor 502). The secondary rotor 502 has permanent magnets disposed on its outer surface in a way similar to that illustrated in FIG. 2 above. The permanent magnets of the secondary rotor 502 may form a two-pole rotor, a four-pole rotor, a six-pole rotor, an eight-pole rotor, and some other number of poles less than 129 poles. The secondary stator 504 is provided with windings that do not receive electric power from the electric motor controller 170. Instead, when the drive shaft 210 turns, the secondary rotor 502 and its permanent magnets turn inside the secondary stator 504 and induces a voltage in the windings of the secondary stator 504 that can be detected at the surface 103, for example by an interface of the electric motor controller 170. This voltage in the windings of the secondary stator 504 can be analyzed by a control program or application executing in the electric motor controller 170 to determine that the drive shaft 210 and hence the rotor 200 is turning or is not turning and to take action accordingly (e.g., to proceed with start-up of the electric motor 110 or to interrupt start-up of the electric motor). Because the secondary stator 504 is not intended to generate significant electric power, the windings of the secondary stator 504 can be simple and need not be 3-phase windings. Likewise, the secondary rotor 502 can be simple and have a limited number of permanent magnets because it is not intended to promote generation of significant electric power, just enough voltage to act as an indication that the electric motor 110 is turning. In an embodiment, the secondary rotor 502 and the secondary stator 504 extend about 4 inches in the axial direction. Alternatively, the secondary rotor 502 and secondary stator 504 extend about 2 inches, about 3 inches, about 5 inches, about 6 inches, about 7 inches, about 8 inches, about 10 inches, or about 12 inches in the axial direction.

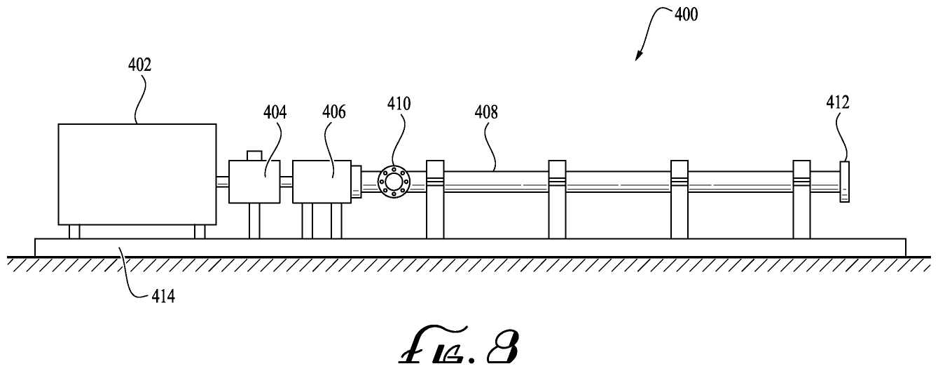

Turning now to FIG. 8, a horizontal pumping system (HPS) 400 is described. In an embodiment, the HSP 400 comprises a motor 402, a rotational coupling 404, a mechanical seal 406, and a centrifugal pump assembly 408. In an embodiment, a fluid inlet 410 is integrated into a first end of the centrifugal pump assembly 408 and a fluid outlet 412 may be integrated into a second end of the centrifugal pump assembly 408. The motor 402, the rotational coupling 404, the mechanical seal 406, and the centrifugal pump assembly 408 may be mounted on a skid 414 such that it can be easily transported to a location on a truck and placed on the ground at the location. The centrifugal pump assembly 408 is substantially similar to the pump assembly 116 described above with reference to FIG. 1. For example, the centrifugal pump assembly 408 comprises a plurality of pump stages, where each pump stage comprises an impeller coupled to a drive shaft of the centrifugal pump assembly 408 and a diffuser that is retained by a housing of the centrifugal pump assembly 408. In an embodiment, the centrifugal pump assembly 408 comprises from one to four hundred pump stages.

The motor 402 may be an electric motor, a hydraulic turbine, or an air turbine. When the motor 402 turns, the drive shaft of the centrifugal pump assembly 408 turns, turning the impellers of the centrifugal pump assembly 408. The torque provided by the motor 402 is transferred via the rotational coupling 404 to the drive shaft of the centrifugal pump assembly 408.

The HSP 400 may be applied for use in a variety of different surface operations. The HSP 400 can be used as a crude oil pipeline pressure and/or flow booster. The HSP 400 can be used in a mine dewatering operation (e.g., removing water from a mine). The HSP 400 can be used in geothermal energy applications, for example to pump geothermal water from a wellhead through a pipe to an end-use or energy conversion facility. The HSP 400 can be used in carbon sequestration operations. The HSP 400 can be used in salt water disposal operations, for example receiving salt water from a wellbore and pumping the salt water under pressure down into a disposal well. The HSP 400 can be used in desalinization operations. In any of these surface pumping applications, the novel structures and techniques described above to determine an angular position of the rotor of the motor 402 and/or to detect that the motor 402 is turning. The HSP 400 may comprise an angular position encoder and angular position instrument as described above installed for determining an angular position of the motor 402.

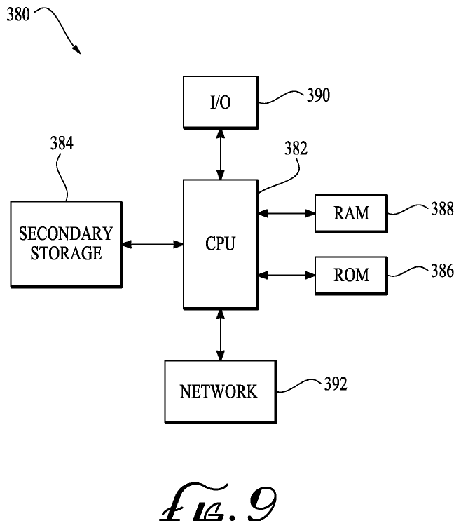

FIG. 9 illustrates a computer system 380 suitable for implementing one or more embodiments disclosed herein. For example, in an embodiment, the electric motor controller 170 may be implemented, at least in part, in a form similar to that of computer system 380. In an embodiment, a processor device having the general architecture of the computer system 380 that is separate from the electric motor controller 170 may receive the indications of the angular position θ 234 of the rotor 200, described above, process these indications, and send control signals (generated by this processor device based on processing the angular position indications) to the electric motor controller 170. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

### ADDITIONAL DISCLOSURE

The following are non-limiting, specific embodiments in accordance with the present disclosure.
A first embodiment, which is an electric submersible pump (ESP) assembly comprising an electric submersible motor having a stator, a rotor, and a first drive shaft, wherein the rotor is coupled to the first drive shaft; a seal section having a second drive shaft coupled to the first drive shaft; a pump assembly having a third drive shaft coupled to the second drive shaft; and an angular position instrument that is configured to determine an angular position of the rotor and to transmit an indication of the angular position of the rotor to an electric motor controller.
A second embodiment, which is the ESP assembly of the first embodiment, wherein the angular position instrument is configured to determine the angular position of the rotor relative to the stator.
A third embodiment, which is the ESP assembly of the first or the second embodiment, wherein the electric submersible motor is a permanent magnet electric submersible motor (PMESM) and the rotor comprises a plurality of permanent magnets.
A fourth embodiment, which is the ESP assembly of any of the first through the third embodiment, wherein the angular position instrument is disposed inside the seal section and wherein the ESP assembly further comprises an angular position encoder mechanically coupled to the second drive shaft.
A fifth embodiment, which is the ESP assembly of any of the first through the fourth embodiment, wherein the angular position instrument is disposed inside the pump assembly and wherein the ESP assembly further comprises an angular position encoder that is mechanically coupled to the third drive shaft.
A sixth embodiment, which is the ESP assembly of any of the first through the fourth embodiment, wherein the angular position instrument is disposed inside the electric submersible motor and wherein the ESP assembly further comprises an angular position encoder that is mechanically coupled to the first drive shaft.
A seventh embodiment, which is the ESP assembly of any of the first through the fourth embodiment, wherein the angular position instrument is disposed inside the electric submersible motor, wherein the ESP assembly further comprises an angular position encoder that is mechanically coupled to the first drive shaft, wherein a second angular position instrument is disposed inside the pump assembly, wherein the second angular position instrument is configured to determine an angular position of the third drive shaft, and wherein the ESP assembly further comprises a second angular position encoder that is mechanically coupled to the third drive shaft
An eighth embodiment, which is the ESP assembly of the seventh embodiment, wherein the angular position encoder comprises a plurality of metal lugs that extend different amounts from a hub of the angular position encoder, wherein the angular position instrument determines the angular position of the rotor based on detecting the metal lugs and their different extensions from the hub, wherein the second angular position encoder comprises a second plurality of metal lugs that extend different amounts from a second hub of the second angular position encoder, wherein the second angular position instrument determines the angular position of the third drive shaft based on detecting the second plurality of metal lugs and their different extensions from the second hub.
A ninth embodiment, which is the ESP assembly of any of the fifth or the sixth embodiment, wherein the angular position encoder comprises a plurality of metal lugs that extend different amounts from a hub of the angular position encoder and wherein the angular position instrument determines the angular position of the rotor based on detecting the metal lugs and their different extensions from the hub.
A tenth embodiment, which is the ESP assembly of any of the eighth or the ninth embodiment, wherein the different extensions of a majority of adjacent metal lugs are staggered with reference to each other.
An eleventh embodiment, which is the ESP assembly of any of the fifth through the eighth embodiment, wherein the angular position encoder comprises a plurality of permanent magnets, wherein each permanent magnet of the angular position encoder is disposed in one of a plurality of circular tracks of the angular position encoder.
A twelfth embodiment, which is the ESP assembly of the eleventh embodiment, wherein the permanent magnets of the angular position encoder are rare earth permanent magnets.
A thirteenth embodiment, which is the ESP assembly of the eleventh embodiment, wherein the permanent magnets of the angular position encoder are samarium-cobalt rare earth permanent magnets.
A fourteenth embodiment, which is the ESP assembly of the eleventh embodiment, wherein the permanent magnets of the angular position encoder are neodymium rare earth permanent magnets.
A fifteenth embodiment, which is the ESP assembly of the third embodiment, wherein the rotor comprises rare earth permanent magnets.
A sixteenth embodiment, which is the ESP assembly of the third embodiment, wherein the rotor comprises samarium-cobalt rare earth permanent magnets.
A seventeenth embodiment, which is the ESP assembly of the third embodiment, wherein the rotor comprises neodymium rare earth permanent magnets.
An eighteenth embodiment, which is a method of operating an electric submersible pump (ESP) assembly in a wellbore comprising running the ESP assembly of any of the first through the seventeenth embodiment into the wellbore; sending a turn-on electric power signal to the electric submersible motor by an electric motor controller disposed at a surface location via an electric power cable connected to the electric submersible motor; receiving a plurality of indications of the angular position of the rotor by the electric motor controller from the angular position instrument; analyzing the plurality of indications of the angular position of the rotor by the electric motor controller; based on the analyzing the plurality of indications, determining by the electric motor controller that the rotor is not turning; and based on the determination that the rotor is not turning, removing the turn-on electric power from the electric submersible motor by the electric motor controller.
A nineteenth embodiment, which is a method of operating an electric submersible pump (ESP) assembly in a wellbore comprising: running the ESP assembly into the wellbore, wherein the ESP assembly comprises an electric submersible motor having a stator, a rotor, and a first drive shaft, wherein the rotor is coupled to the first drive shaft, a seal section having a second drive shaft coupled to the first drive shaft, a pump assembly having a third drive shaft coupled to the second drive shaft, and an angular position instrument that is configured to determine an angular position of the rotor; sending a turn-on electric power signal to the electric submersible motor by an electric motor controller disposed at a surface location via an electric power cable connected to the electric submersible motor; receiving a plurality of indications of the angular position of the rotor by the electric motor controller from the angular position instrument; analyzing the plurality of indications of the angular position of the rotor by the electric motor controller; based on the analyzing the plurality of indications, determining by the electric motor controller that the rotor is not turning; and based on the determination that the rotor is not turning, removing the turn-on electric power from the electric submersible motor by the electric motor controller.
A twentieth embodiment, which is the method of the nineteenth embodiment, wherein the electric submersible motor is a permanent magnet electric submersible motor (PMESM) and the rotor comprises a plurality of permanent magnets.
A twenty-first embodiment, which is the method of the nineteenth or the twentieth embodiment, further comprising, in response to the determination that the rotor is not turning, sending a pulse of electric power by the electric motor controller to the electric submersible motor.
A twenty-second embodiment, which is any of the method of any of the nineteenth through the twenty-first embodiment, wherein each of the indications of angular position of the rotor sent by the angular position instrument uniquely identifies an angular position of the rotor in the range from a 0 degree position to a 360 degree position.
A twenty-third embodiment, which is the method of any of the nineteenth through the twenty-first embodiment, wherein the indications of angular position of the rotor sent by the angular position instrument uniquely identifies an angular position of the rotor as one of 0 degrees plus or minus 20 degrees, 60 degrees plus or minus 20 degrees, 120 degrees plus or minus 20 degrees, 180 degrees plus or minus 20 degrees, 240 degrees plus or minus 20 degrees, and 300 degrees plus or minus 20 degrees.
A twenty-fourth embodiment, which is the method of any of the nineteenth through the twenty-first embodiment, wherein the indications of angular position of the rotor sent by the angular position instrument uniquely identifies an angular position of the rotor as one of 0 degrees plus or minus 15 degrees, 45 degrees plus or minus 15 degrees, 90 degrees plus or minus 15 degrees, 135 degrees plus or minus 15 degrees, 180 degrees plus or minus 15 degrees, 225 degrees plus or minus 15 degrees, 270 degrees plus or minus 15 degrees, and 315 degrees plus or minus 15 degrees.
A twenty-fifth embodiment, which is the method of any of the nineteenth through the twenty-first embodiment, wherein the indications of angular position of the rotor sent by the angular position instrument uniquely identifies an angular position of the rotor as one of 0 degrees plus or minus 10 degrees, 30 degrees plus or minus 10 degrees, 60 degrees plus or minus 10 degrees, 90 degrees plus or minus 10 degrees, 120 degrees plus or minus 10 degrees, 150 degrees plus or minus 10 degrees, 180 degrees plus or minus 10 degrees, 210 degrees plus or minus 10 degrees, 240 degrees plus or minus 10 degrees, 270 degrees plus or minus 10 degrees, 300 degrees plus or minus 10 degrees, and 330 degrees plus or minus 10 degrees.
A twenty-sixth embodiment, which is the method of any of the nineteenth through twenty-first embodiment, wherein the indications of angular position of the rotor sent by the angular position instrument uniquely identifies an angular position of the rotor as one of 0 degrees plus or minus 5 degrees, 20 degrees plus or minus 5 degrees, 40 degrees plus or minus 5 degrees, 60 degrees plus or minus 5 degrees, 80 degrees plus or minus 5 degrees, 100 degrees plus or minus 5 degrees, 120 degrees plus or minus 5 degrees, 140 degrees plus or minus 5 degrees, 160 degrees plus or minus 5 degrees, 180 degrees plus or minus 5 degrees, 200 degrees plus or minus 5 degrees, 220 degrees plus or minus 5 degrees, 240 degrees plus or minus 5 degrees, 260 degrees plus or minus 5 degrees, 280 degrees plus or minus 5 degrees, 300 degrees plus or minus 5 degrees, 320 degrees plus or minus 5 degrees, and 340 degrees plus or minus 5 degrees.
A twenty-seventh embodiment, which is a method of lifting fluid in a wellbore comprising: running an electric submersible pump (ESP) assembly into the wellbore, wherein the ESP assembly is the ESP assembly of any of the first through the seventeenth embodiment; sending a turn-on electric power signal to the electric submersible motor by an electric motor controller disposed at a surface location via an electric power cable connected to the electric submersible motor; receiving a plurality of indications of the angular position of the rotor by the electric motor controller from the angular position instrument; analyzing the plurality of indications of the angular position of the rotor by the electric motor controller; based on the analyzing the plurality of indications, determining by the electric motor controller that the rotor is turning; based on the determination that the rotor is turning, ramping up electric power to full-on power level to the electric submersible motor by the electric motor controller; and lifting reservoir fluid by the pump assembly to the surface.
A twenty-eighth embodiment, which is a method of lifting fluid in a wellbore comprising: running an electric submersible pump (ESP) assembly into the wellbore, wherein the ESP assembly comprises a electric submersible motor having a stator, a rotor, and a first drive shaft, wherein the rotor is coupled to the first drive shaft, a seal section having a second drive shaft coupled to the first drive shaft, a pump assembly having a third drive shaft coupled to the second drive shaft, and an angular position instrument that is configured to determine an angular position of the rotor; sending a turn-on electric power signal to the electric submersible motor by an electric motor controller disposed at a surface location via an electric power cable connected to the electric submersible motor; receiving a plurality of indications of the angular position of the rotor by the electric motor controller from the angular position instrument; analyzing the plurality of indications of the angular position of the rotor by the electric motor controller; based on the analyzing the plurality of indications, determining by the electric motor controller that the rotor is turning; based on the determination that the rotor is turning, ramping up electric power to full-on power level to the electric submersible motor by the electric motor controller; and lifting reservoir fluid by the pump assembly to the surface.
A twenty-ninth embodiment, which is the method of the twenty-eighth embodiment, wherein the ESP assembly further comprises an angular position encoder mechanically coupled to the first drive shaft, the second drive shaft, or the third drive shaft and wherein the method further comprises the angular position instrument determining the angular position of the rotor by sensing a spatially distinctive feature of the angular position encoder.
A thirtieth embodiment, which is the method of the twenty-ninth embodiment, wherein the angular position encoder comprises a plurality of metal lugs that extend different distances from a hub of the angular position encoder and where the spatially distinctive features of the angular position encoder comprise the different distances each of the metal lugs extends from the hub.
A thirty-first embodiment, which is the method of the twenty-ninth embodiment, wherein the angular position encoder comprises a plurality of permanent magnets disposed in a distinctive pattern at different angular positions on the angular position encoder and where the spatially distinctive features of the angular position encoder comprise the different dispositions of permanent magnets at different angular positions on the angular position encoder.
A thirty-second embodiment, which is a method of operating an electric submersible pump (ESP) assembly in a wellbore comprising: running the ESP assembly into the wellbore, wherein the ESP assembly comprises an electric submersible motor having a stator, a rotor, and a first drive shaft, wherein the rotor is coupled to the first drive shaft, a seal section having a second drive shaft coupled to the first drive shaft, and a pump assembly having a third drive shaft coupled to the second drive shaft; sending a turn-on electric power signal to the electric submersible motor by an electric motor controller disposed at a surface location via an electric power cable connected to the electric submersible motor; receiving a voltage signal from the electric motor by the electric motor controller; analyzing the received voltage signal by the electric motor controller; based on the analyzing the received voltage signal, determining by the electric motor controller that the rotor is turning; and based on the determination that the rotor is turning, ramping up electric power to full-on power level to the electric submersible motor by the electric motor controller.
A thirty-third embodiment, which is the method of the thirty-second embodiment, wherein the electric submersible motor is a permanent magnet electric submersible motor (PMESM) and the rotor comprises a plurality of permanent magnets.
A thirty-fourth embodiment, which is the method of the thirty-second or thirty-third embodiment, wherein the electric submersible motor is a three-phase electric motor, wherein the turn-on electric power sent by the electric motor controller to the electric submersible motor sends electric power to a first phase winding and to a second phase winding of the stator of the electric submersible motor, and wherein the voltage signal received by the electric motor controller from the electric submersible motor is generated in a third phase winding of the stator of the electric submersible motor.
A thirty-fifth embodiment, which is the method of the thirty-second of thirty-third embodiment, wherein the electric submersible motor further comprises a secondary rotor having permanent magnets and a secondary stator, wherein the voltage signal receive by the electric motor controller from the electric submersible motor is generated in a winding of the secondary stator.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. An electric submersible pump (ESP) assembly, comprising:
an electric submersible motor having a stator, a rotor, and a first drive shaft, wherein the rotor is coupled to the first drive shaft
a seal section having a second drive shaft coupled to the first drive shaft;
a pump assembly having a third drive shaft coupled to the second drive shaft; and
an angular position instrument that is configured to determine an angular position of the rotor and to transmit an indication of the angular position of the rotor to an electric motor controller.

2. The ESP assembly of claim 1, wherein the angular position instrument is disposed inside the seal section and wherein the ESP assembly further comprises an angular position encoder mechanically coupled to the second drive shaft.

3. The ESP assembly of claim 1, wherein the angular position instrument is disposed inside the pump assembly and wherein the ESP assembly further comprises an angular position encoder that is mechanically coupled to the third drive shaft.

4. The ESP assembly of claim 1, wherein the angular position instrument is disposed inside the PMESM and wherein the ESP assembly further comprises an angular position encoder that is mechanically coupled to the first drive shaft.

5. The ESP assembly of claim 4, wherein the angular position encoder comprises a plurality of metal lugs that extend different amounts from a hub of the angular position encoder and wherein the angular position instrument determines the angular position of the rotor based on detecting the metal lugs and their different extensions from the hub.

6. The ESP assembly of claim 5, wherein the different extensions of a majority of adjacent metal lugs are staggered with reference to each other.

7. The ESP assembly of claim 4, wherein the angular position encoder comprises a plurality of permanent magnets, wherein each permanent magnet of the angular position encoder is disposed in one of a plurality of circular tracks of the angular position encoder.

8. The ESP assembly of claim 1, wherein the electric submersible motor is a permanent magnet electric submersible motor (PMESM) and wherein the rotor comprises a plurality of permanent magnets.

9. The ESP assembly of claim 1, wherein the electric submersible motor is an AC induction motor.

10. A method of operating an electric submersible pump (ESP) assembly in a wellbore, comprising:
running the ESP assembly into the wellbore, wherein the ESP assembly comprises
an electric submersible motor having a stator, a rotor, and a first drive shaft, wherein the rotor is coupled to the first drive shaft,
a seal section having a second drive shaft coupled to the first drive shaft,
a pump assembly having a third drive shaft coupled to the second drive shaft, and
an angular position instrument that is configured to determine an angular position of the rotor;
sending a turn-on electric power signal to the electric submersible motor by an electric motor controller disposed at a surface location via an electric power cable connected to the electric submersible motor;
receiving a plurality of indications of the angular position of the rotor by the electric motor controller from the angular position instrument;
analyzing the plurality of indications of the angular position of the rotor by the electric motor controller;
based on the analyzing the plurality of indications, determining by the electric motor controller that the rotor is not turning; and
based on the determination that the rotor is not turning, removing the turn-on electric power from the electric submersible motor by the electric motor controller.

11. The method of claim 10, in response to the determination that the rotor is not turning, sending a pulse of electric power by the electric motor controller to the electric submersible motor.

12. The method of claim 10, wherein each of the indications of angular position of the rotor sent by the angular position instrument uniquely identifies an angular position of the rotor in the range from a 0 degree position to a 360 degree position.

13. The method of claim 10, wherein the indications of angular position of the rotor sent by the angular position instrument uniquely identifies an angular position of the rotor as one of 0 degrees plus or minus 20 degrees, 60 degrees plus or minus 20 degrees, 120 degrees plus or minus 20 degrees, 180 degrees plus or minus 20 degrees, 240 degrees plus or minus 20 degrees, and 300 degrees plus or minus 20 degrees.

14. The method of claim 10, wherein the indications of angular position of the rotor sent by the angular position instrument uniquely identifies an angular position of the rotor as one of 0 degrees plus or minus 15 degrees, 45 degrees plus or minus 15 degrees, 90 degrees plus or minus 15 degrees, 135 degrees plus or minus 15 degrees, 180 degrees plus or minus 15 degrees, 225 degrees plus or minus 15 degrees, 270 degrees plus or minus 15 degrees, and 315 degrees plus or minus 15 degrees.

15. The method of claim 10, wherein the indications of angular position of the rotor sent by the angular position instrument uniquely identifies an angular position of the rotor as one of 0 degrees plus or minus 10 degrees, 30 degrees plus or minus 10 degrees, 60 degrees plus or minus 10 degrees, 90 degrees plus or minus 10 degrees, 120 degrees plus or minus 10 degrees, 150 degrees plus or minus 10 degrees, 180 degrees plus or minus 10 degrees, 210 degrees plus or minus 10 degrees, 240 degrees plus or minus 10 degrees, 270 degrees plus or minus 10 degrees, 300 degrees plus or minus 10 degrees, and 330 degrees plus or minus 10 degrees.

16. The method of claim 10, wherein the indications of angular position of the rotor sent by the angular position instrument uniquely identifies an angular position of the rotor as one of 0 degrees plus or minus 5 degrees, 20 degrees plus or minus 5 degrees, 40 degrees plus or minus 5 degrees, 60 degrees plus or minus 5 degrees, 80 degrees plus or minus 5 degrees, 100 degrees plus or minus 5 degrees, 120 degrees plus or minus 5 degrees, 140 degrees plus or minus 5 degrees, 160 degrees plus or minus 5 degrees, 180 degrees plus or minus 5 degrees, 200 degrees plus or minus 5 degrees, 220 degrees plus or minus 5 degrees, 240 degrees plus or minus 5 degrees, 260 degrees plus or minus 5 degrees, 280 degrees plus or minus 5 degrees, 300 degrees plus or minus 5 degrees, 320 degrees plus or minus 5 degrees, and 340 degrees plus or minus 5 degrees.

17. A method of lifting fluid in a wellbore, comprising:
running an electric submersible pump (ESP) assembly into the wellbore, wherein the ESP assembly comprises
an electric submersible motor having a stator, a rotor, and a first drive shaft, wherein the rotor is coupled to the first drive shaft,
a seal section having a second drive shaft coupled to the first drive shaft,
a pump assembly having a third drive shaft coupled to the second drive shaft, and
an angular position instrument that is configured to determine an angular position of the rotor;
sending a turn-on electric power signal to the electric submersible motor by an electric motor controller disposed at a surface location to the electric submersible motor via an electric power cable connected to the electric submersible motor;
receiving a plurality of indications of the angular position of the rotor by the electric motor controller from the angular position instrument;
analyzing the plurality of indications of the angular position of the rotor by the electric motor controller;
based on the analyzing the plurality of indications, determining by the electric motor controller that the rotor is turning;
based on the determination that the rotor is turning, ramping up electric power to full-on power level to the electric submersible motor by the electric motor controller; and
lifting reservoir fluid by the pump assembly to the surface.

18. The method of claim 17, wherein the ESP assembly further comprises an angular position encoder mechanically coupled to the first drive shaft, the second drive shaft, or the third drive shaft and wherein the method further comprises the angular position instrument determining the angular position of the rotor by sensing a spatially distinctive feature of the angular position encoder.

19. The method of claim 17, wherein the angular position encoder comprises a plurality of metal lugs that extend different distances from a hub of the angular position encoder and where the spatially distinctive features of the angular position encoder comprise the different distances each of the metal lugs extends from the hub.

20. The method of claim 17, wherein the angular position encoder comprises a plurality of permanent magnets disposed in a distinctive pattern at different angular positions on the angular position encoder and where the spatially distinctive features of the angular position encoder comprise the different dispositions of permanent magnets at different angular positions on the angular position encoder.

21. A method of operating an electric submersible pump (ESP) assembly in a wellbore, comprising:
running the ESP assembly into the wellbore, wherein the ESP assembly comprises a permanent magnet electric submersible motor (PMESM) having a stator,
a rotor, and a first drive shaft, wherein the rotor is coupled to the first drive shaft and comprises a plurality of permanent magnets,
a seal section having a second drive shaft coupled to the first drive shaft, and
a pump assembly having a third drive shaft coupled to the second drive shaft;
sending a turn-on electric power signal to the PMESM by an electric motor controller disposed at a surface location via an electric power cable connected to the PMESM;
receiving a voltage signal from the PMESM by the electric motor controller;
analyzing the received voltage signal by the electric motor controller;
based on the analyzing the received voltage signal, determining by the electric motor controller that the rotor is turning; and
based on the determination that the rotor is turning, ramping up electric power to full-on power level to the PMESM by the electric motor controller.

22. The method of claim 21, wherein the PMESM is a three-phase electric motor, wherein the turn-on electric power sent by the electric motor controller to the PMESM sends electric power to a first phase winding and to a second phase winding of the stator of the PMESM, and wherein the voltage signal received by the electric motor controller from the PMESM is generated in a third phase winding of the stator of the PMESM.

23. The method of claim 21, wherein the PMESM further comprises a secondary rotor having permanent magnets and a secondary stator, wherein the voltage signal received by the electric motor controller from the PMESM is generated in a winding of the secondary stator.
